(19) United States
(12) Patent Application Publication
(10) Pub. No.: US 2023/0321719 A1
(43) Pub. Date: Oct. 12, 2023

(54) Fe-Cr-Al powder for use in additive manufacturing

(71) Applicant: Kanthal AB, Hallstahammar (SE)

(72) Inventors: Roger BERGLUND, Hallstahammar (SE); Durga ANANTHANARAYANAN, Enebyberg (SE); Greta LINDWALL, Trångsund (SE)

(73) Assignee: Kanthal AB, Hallstahammar (SE)

(21) Appl. No.: 17/923,977

(22) PCT Filed: May 12, 2021
(86) PCT No.: PCT/EP2021/062656

§ 371 Date: Nov. 8, 2022

(30) Foreign Application Priority Data
May 12, 2020 (EP) 20174269.9

(51) Int. Cl. B22F 1/05; B33Y 70/00; B22F 10/28; B33Y 80/00; B33Y 10/00

(52) U.S. Cl. CPC B22F 1/05; B33Y 70/00; B22F 10/28; B33Y 80/00; B33Y 10/00; B22F 2301/355; B22F 2301/205; B22F 2301/052

(57) ABSTRACT

The present disclosure relates to an iron-chromium-aluminum (Fe—Cr—Al) powder suitable for additive manufacturing and to an additive manufacturing process. The present disclosure also relates to an additive manufactured object.

### TECHNICAL FIELD

The present disclosure relates to a powder suitable for additive manufacturing. More specifically, the present disclosure relates to an iron-chromium-aluminum (Fe—Cr—Al) powder having a specific chemical composition to be used in additive manufacturing processes. Further, the present disclosure relates to a process for manufacturing a three-dimensional object using an additive manufacturing process and said Fe—Cr—Al powder. Also, the present disclosure relates to an additive manufactured object comprising the Fe—Cr—Al powder.

### BACKGROUND

Additive manufacturing is defined as a process of joining materials layer-by-layer to build objects from a three-dimensional data model. Metal-based additive manufacturing permits layer-by-layer production of near net-shaped metallic components with complex geometries not restricted by the process limitations of traditional manufacturing.

Objects comprising iron-chromium-aluminum (Fe—Cr—Al) powder are attractive to use in electrical heating and high temperature applications. However, one of the problems with objects made from these powders using additive manufacturing processes, is the objects tendency to crack during and after production. In additive manufacturing processes such as selective laser melting (SLM), electron beam melting (EBM) and direct energy deposition (DED), the re-solidification is dominated by epitaxial growth of crystals from the previously solidified layers. The solidified material will predominately consist of large columnar grains with a very large extension in the building direction. Such a coarse and elongated structure makes the Fe—Cr—Al object brittle at low temperatures. The process of layer-by-layer melting and solidification also create high thermal stresses in the built objects. As a result, the produced three-dimensional object tends to crack during and after production due to residual stresses in combination with columnar structures. One reason for this may be that the Fe—Cr—Al powder compositions used in additive manufacturing are based on conventional compositions, i.e. these compositions are still tailored for conventional manufacturing processes. Hence, these compositions may not be adapted to the directional thermal gradient provoking epitaxial growth during additive manufacturing which may result in heavily textured microstructures associated with anisotropic structural properties and cracking. Thus, it may be both difficult and complicated to manufacture complex structures in these Fe—Cr—Al powders.

Document CN 110125383 discloses a ferritic Fe—Cr—Al powder composition wherein the Fe—Cr—Al powder composition comprises in weight % is: Cr 18 to 34; Al 4 to 6; Si≤0.5; Ti≤0.5; Y≤1; Zr≤0.5; balance Fe. However, even if a powder composition is disclosed and they mention that it might be used in additive manufacturing processes, no actual additive manufactured product is disclosed.

Consequently, there still exist a need in this technical field for a ferritic Fe—Cr—Al alloy powder having a chemical composition which has been specifically adapted for additive manufacturing which will provide an object free of cracks.

The present disclosure aims at solving or at least reducing the above-mentioned problem.

### SUMMARY

The present disclosure therefore provides a ferritic iron-chromium-aluminum (Fe—Cr—Al) powder composition which has been optimized for additive manufacturing of a three-dimensional object.

The Fe—Cr—Al powder according to the present disclosure is characterized in that the powder has the following composition (in weight %):
Cr 12.0 to 25.0;
Al 3.50 to 6.50;
Ti 0.20 to 1.10;
N 0.06 to 0.20;
Zr 0.05 to 0.20;
Y 0.02 to 0.15;
C≤0.050;
Si≤0.50;
Hf≤0.30;
Ta≤0.30;
Mn≤0.40;
Ni≤0.60;
O≤600 ppm;
balance is Fe and unavoidable impurities;
wherein TiN is present as inoculant.

In the present disclosure, TiN is present as an inoculant in the Fe—Cr—Al powder. It has been shown that the inoculant will provide for many advantages during the additive manufacturing process and in an object manufactured thereof. In particular, the TiN inoculants will introduce grain refinement and will also provide for a nearly isotropic grain structure as will be disclosed further below.

The present disclosure furthermore provides a process for manufacturing a three-dimensional object using an additive manufacturing process and the Fe—Cr—Al powder composition as defined hereinabove or hereinafter. It has surprisingly been found that by using an additive manufacturing process and the present Fe—Cr—Al powder, crack free objects with complicated design and geometries will be obtained in a cost and time efficient way. In particular, it has been found that the TiN inoculants will refine the solidification structures during the additive manufacturing process whereby an object with improved material quality, particularly due to the more equiaxed as-solidified grain structure will be obtained.

The present disclosure additionally relates to a crack-free additive manufactured object which has been obtained by using the Fe—Cr—Al powder as defined hereinabove or hereinafter powder and also comprising the same alloying elements in the same ranges as the powder. The crack-free object, which may have complicated design and geometry, will perform well in high temperature applications. It has surprisingly been found that the TiN inoculants in the Fe—Cr—Al powder will limit the cracking behavior during the manufacturing processes by promoting nucleation which in turn will result in a break-up of the columnar structure and thereby provide an object with improved properties. By crack-free is meant that no cracks can be found neither macroscopically nor microscopically.

### BRIEF DESCRIPTION OF FIGURES

FIGS. 1a-d. show SEM micrographs of Fe—Cr—Al powder particles of different compositions;

FIGS. 2a-b. show printed cubes which are composed of different Fe—Cr—Al powder compositions;

FIGS. 3a-b. show EBSD micrographs of printed cubes which are composed of different Fe—Cr—Al powder compositions.

### DETAILED DESCRIPTION

The present disclosure relates to a Fe—Cr—Al powder characterized in that the powder has the following composition (in weight %)
Cr 12.0 to 25.0;
Al 3.50 to 6.50;
Ti 0.20 to 1.10;
N 0.06 to 0.20;
Zr 0.05 to 0.20;
Y 0.02 to 0.15;
C≤0.050;
Si≤0.50;
Hf≤0.30;
Ta≤0.30;
Mn≤0.40;
Ni≤0.60;
O≤600 ppm;
balance is Fe and unavoidable impurities;
wherein TiN is present as inoculant.

The alloying elements of the powder according to the present disclosure will now be described in more detail. The terms “weight %” and “wt %” are used interchangeably. Also, the list of properties or contributions mentioned for a specific element should not be considered exhaustive.

Iron (Fe)

The main function for iron in the Fe—Cr—Al powder is to balance the powder composition or the composition of alloying elements of the object.

Chromium (Cr) 12.0 to 25.0 wt % Chromium is an important element since it will improve the corrosion resistance of the obtained object and increase its tensile and yield strength. Further, chromium facilitates the formation of the A1203 layer on the final object through the so-called third element effect, i.e. by formation of chromium oxide in the transient oxidation stage. Too low amount of chromium will result in loss of corrosion resistance. Thus, chromium shall be present an amount of at least 12.0 wt %, such as at least 15.0 wt %, such as at least 20.0 wt %. Too much chromium will enable a to a′decomposition and 475° C. embrittlement and will also lead to an increased solid solutioning hardening effect on the ferritic structure. Thus, the maximum content of chromium is set to 25.0 wt.%, such as maximum 24.0 wt.%, such as maximum 23.50 wt.%, such as maximum 23.0 wt %, such as maximum 22.50 wt %, such as maximum 22.0 wt %, such as maximum 21.50 wt %. According to embodiments, the content of chromium is from 12.0 to 25.0 wt %, such as from 18.0 0 to 24.0 wt %, such as from 20.0 to 23.50 wt %.

Aluminum (Al) 3.50 to 6.50 wt %

Aluminum is an important element since aluminum, when exposed to oxygen at high temperatures, will form a dense and thin Al₂O₃ layer on the surface of the manufactured object, which will protect the underlying surface from further oxidation. Further, aluminum increases the electrical resistivity. At too low amounts of aluminum, there will be a loss of the ability for the formation of the Al₂O₃ layer and thereby electrical resistivity will be reduced. Thus, aluminum shall be present in an amount of at least 3.50 wt %, such as at least 4.00 wt %, such as at least 4.50 wt %, such as at least 4.80 wt %. Too high content of aluminum will cause brittleness at low temperatures and will also enhance the formation of unwanted brittle aluminides. Thus, the maximum aluminum is set to 6.50 wt.%, such as maximum 6.00 wt.%, such as maximum 5.50 wt.%, such as maximum 5.40 wt %, such as maximum 5.30 wt %, such as maximum 5.20 wt %. According to embodiments of the present disclosure, the content of aluminum is from 3.50 to 6.50 wt %, such as from 4.00 to 5.50 wt %, such as from 4.50 to 5.50 wt %.

Titanium (Ti) 0.20 to 1.10 wt %

Titanium is an important element since titanium will together with nitrogen form TiN. According to an embodiment, due to the molar weights of Ti and N, the ratio of Ti/N in weight-% should be at least 3.3, such as at least 4.5.

Additionally, titanium may also reduce the activity of carbon by the formation of TiC and may furthermore improve high temperature creep strength. A too low amount of Ti will result in that not enough TiN inoculates is present in the present powder for nucleation of ferrite crystals during solidification in the additive manufacturing process. Further, at too low content of Ti, there will be a high risk of the formation of unwanted chromium carbides and/or brittle aluminum nitrides. Hence, titanium shall be present in an amount of at least 0.20 wt %, such as at least 0.25 wt %, such as at least 0.30 wt %. On the other hand, a too high content of titanium may have a negative effect on the formation of Al₂O₃ as TiO₂ may be formed. For these reasons, the maximum content of Ti is set to 1.10 wt. %, such as maximum 1.00 wt. %, such as maximum 0.90 wt. %, such as maximum 0.8 wt. %. According to embodiments of the present disclosure, the content of Ti is from 0.20 to 0.80 wt % such as from 0.20 to 0.70 wt %, such as from 0.24 to 0.60 wt %.

Nitrogen (N) 0.06 to 0.20 wt %

Nitrogen is an important element since nitrogen will together with titanium form a TiN particle. In the present disclosure, TiN will function as an inoculant and is therefore a desired particle. According to embodiments, due to the molar weights of Ti and N, the ratio of Ti/N in weight-% should be at least 3.3, such as at least 4.5.

Nitrogen is also an important element as it will enable precipitation of other metallic nitrides, such as ZrN. ZrN will improve the high temperature creep resistance. However, too low amounts of nitrides will be formed if the nitrogen content is too low. Accordingly, the nitrogen shall be present in an amount of at least 0.06 wt %, such as at least 0.07 wt %, such as at least 0.08 wt %, such as at least 0.09 wt %. Further, if the nitrogen content is too high in relation to the titanium content, there may be a risk that AlN will be formed, which will have a negative impact on the oxidation resistance. For these reasons, the maximum content of N is set to 0.20 wt.%, such as maximum 0.15 wt.%, such as maximum 0.10 wt.%. According to embodiments of the present disclosure, the content of N is from 0.060 to 0.20 wt % such as from 0.07 to 0.15 wt % such as from 0.07 to 0.12 wt %.

TiN Inoculants

The Fe—Cr—Al powder as defined hereinabove or hereinafter will have homogenously distributed TiN inoculants in the powder. TiN is a desired inoculant which will introduce both grain refinement and a more isotropic grain structure in the additive manufactured object.

It has been shown that by using the Fe—Cr—Al powder of the present disclosure in an additive manufacturing process, the extent of grain boundary alignment will be reduced and which will provide the manufactured object with increased crystallographic diversity.

A further advantage of the TiN inoculants is that they will provide grain refinement in the obtained object which has been manufactured by additive manufacturing. The resulting grain structure of the obtained object has a significantly reduced average grain size compared to a typical conventional additively manufactured material without these TiN inoculants.

Another advantage is that the TiN inoculants in the present Fe—Cr—Al powder may allow manipulation of the solidification conditions during an additive manufacturing process and therefore time consuming conditioning between layers will be unnecessary.

It has been found that by the introduction of TiN inoculants in a Fe—Cr—Al powder it will be possible to have a refinement of solidification structures in additive manufacturing as the TiN inoculants will act as nucleus for ferrite crystal formation and thereby provide for the formation of a finer grain structure. TiN is thermodynamically stable in a liquid alloy and will be formed prior to ferrite crystals during solidification and will thereby act as an effective nucleation site for ferrite crystals at the temperatures where ferrite solidifies. Without being bound to any theory it is believed that the undercooling required for nucleation of ferrite on TiN particles will be very low due to the good lattice matching between the lattice structures of the TiN particle and the ferrite crystal and low interfacial energy. Moreover, the good coherency between TiN and ferrite will also reduce stresses in the formed object.

The TiN inoculant size and/or size distribution may determine the undercooling for equiaxed growth. For this reason, according to embodiments the average size of a TiN inoculant is at least 30 nm, such as at least 50 nm, such as at least 100 nm.

Further, it may be advantageous with the presence of oxides in the present Fe—Cr—Al powder, such as corundum, during the solidification conditions of high cooling rates in order for TiN inoculants to nucleate and grow.

Hence, the homogenous and finely dispersed TiN inoculants in the present Fe—Cr—Al powder will provide a more isotropic and fine-grained solidification structure with a more random crystallographic orientation during the layer-by-layer process in additive manufacturing. This will provide for reduced cracking behavior during and/or after additive manufacturing of the Fe—Cr—Al object. The lower residual stresses and less formed columnar grain structure formed during additive manufacturing will enable a more crack free additive manufactured object.

Zirconium (Zr) 0.05 to 0.20 wt %

Zirconium is an important element in the present powder composition as zirconium will reduce the activity of C and N by the formation of ZrC or ZrN precipitates. Zirconium can also improve the high temperature creep strength of a manufactured object. Too low amount of Zr will increase the risk of the formation of unwanted chromium carbides and/or aluminum nitrides. Accordingly, zirconium shall be present in an amount of at least 0.05 wt %, such as at least 0.07 wt %, such as at least 0.10 wt %. On the other hand, a too high content of zirconium may have a negative impact on the formation of Al₂O₃. For these reasons, the maximum content of zirconium is set to 0.20 wt. %, such as maximum 0.15 wt. %. According to embodiments of the present disclosure, the content of zirconium is from 0.05 to 0.20 wt %, such as from 0.07 to 0.20 wt %, such as from 0.070 to 0.10 wt %.

Yttrium (Y) 0.02 to 0.15 wt %

The addition of yttrium improves the oxidation resistance of a manufactured object. Too little amount of added yttrium will result in reduced oxidation resistance. For this reason, yttrium must be added in the amount of at least 0.02 wt %, such as at least 0.04 wt %, such as 0.05 wt %, such as 0.06 wt %. However, if too much yttrium is added, this will cause hot embrittlement. As a result, the maximum content of yttrium content is set to 0.15 wt %, such as 0.10 wt %, such as 0.08 wt %.

Carbon (C)≤0.050 wt %

Carbon is an element which is not added on purpose but is an unavoidable element due to powder handling. This element may cause reduction in hot ductility and formation of metallic carbides. Thus, in order to limit the presence of too many metallic carbide precipitates, the carbon content must be ≤0.050 wt %, such as ≤0.040 wt %, such as ≤0.030 wt %.

Silicon (Si)≤0.50 wt %

Silicon may be present in levels of up to 0.50 wt % in order to increase electrical resistivity and to increase hot corrosion resistance. However, above this level, the hardness will increase and also there will be brittleness at low temperatures.

Tantalum (Ta)≤0.30 wt %

Tantalum may optionally be added and if added, tantalum will improves the high temperature creep strength. Tantalum may also reduce the carbon activity by the formation of TaC precipitates and therefore the maximum tantalum content is set to 0.30 wt %.

Hafnium (Hf)≤0.30 wt %

Hafnium may optionally be added. The addition of hafnium will improve the high temperature creep strength. However, hafnium may reduce the carbon activity by the formation of HfC precipitates. Therefore, the maximum hafnium content is set to ≤0.30 wt %.

Manganese (Mn)≤0.40 wt %

Manganese may be present as an impurity. Manganese may disturb the formation of the Al₂O₃ layer and thus have a negative impact on the oxidation resistance. Thus, the maximum content of manganese is ≤0.40 wt %, such as ≤0.20 wt %.

Nickel (Ni)≤0.60 wt %

Nickel may be present as an impurity. Nickel may however increase the hardness and brittleness at low temperatures. Thus, the maximum content of nickel is therefore ≤0.60 wt %, such as ≤0.5 wt %.

Oxygen (O)≤600 ppm

Oxygen may be present in the form of oxides. The maximum content allowed i is ≤600 ppm.

According to embodiments, the powder may also include minor fractions of one or more of the following impurity elements such as but not limited to; Magnesium (Mg), Cerium (Ce), Calcium (Ca), Phosphorus (P), Tungsten (W), Cobalt (Co), Sulphur (S), Molybdenum (Mo), Niobium (Nb), Vanadium (V) and Copper (Cu) and in an amount up to 0.2 wt %.

Additionally, the Fe—Cr—Al powder as defined hereinabove or hereinafter may comprise the alloying elements mentioned herein in any of the ranges mentioned herein. According to one embodiment, the present powder consists of all the alloying elements mentioned herein, in any of the ranges mentioned herein.

Moreover, the additive manufactured object as defined hereinabove or hereinafter may comprise or consist of the alloying elements of the Fe—Cr—Al powder as defined hereinabove or hereinafter herein, in any of the ranges mentioned herein.

The Fe—Cr—Al powder as defined hereinabove or hereinafter may be manufactured through different methods. For example, but not limiting to:
directly by gas atomization;
heating a powder comprising all the alloying element in the ranges mentioned hereinabove or hereinafter but with a low nitrogen content in a nitrogen rich atmosphere, i.e. nitriding the powder;
mixing a powder comprising all the alloying element in the ranges mentioned hereinabove or hereinafter but with a low nitrogen content with a powder containing fine particle of less stable nitride;
mixing fine/small particles of TiN with a Fe—Cr—Al powder so that the obtained powder will have the same alloying element composition as defined hereinabove or hereinafter.

According to embodiments, the Fe—Cr—Al powder particle (average) size is less than 200 μm, such as less than less than 120 μm, such as less than 100 μm in order to be suitable for use in additive manufacturing processes.

According to embodiments, the Fe—Cr—Al powder size distribution may be selected from 4 to 200 μm, such as 10 to 120 μm, such as 10 to 90 μm.

The present disclosure also relates to a process for manufacturing a three-dimensional object using an additive manufacturing process and the Fe—Cr—Al powder composition as defined hereinabove or hereinafter.

According to embodiments, the additive manufacturing process is selected from a powder bed fusion process or Direct Energy Deposition (DED) process.

In powder bed fusion additive manufacturing processes, a layer of powder is melted selectively using for example a high-power laser. Due to the small interaction volumes and melt pools, the cooling rate is extremely high during the process. As a consequence, the microstructure will be very different compared to the forged or cast objects using the same powder composition.

During a powder bed fusion additive manufacturing process, the TiN inoculants in the Fe—Cr—Al powder will be present in the melt prior to solidification and promote grain refinement by acting as nucleation sites for the solidifying melt. Solidification by growth of crystals nucleated on TiN particles will compete with epitaxial growth of crystals from the previously solidified material. Crystals nucleated on TiN inoculants in the supercooled melt will grow as equiaxed grains until they become incorporated by the epitaxial solidification front or until they connect to other solidification structure during the additive manufacturing process.

According to one embodiment, the powder bed fusion manufacturing process is selected from selective laser melting (SLM) or electron beam melting (EBM). In both these embodiments, a powder bed is used, the powder is provided as a layer and an energy source will pass over the areas of the layer of powder to be melted whereby the powder is exposed to the energy source and therefore melted or at least partially melted. After the desired parts of a powder layer have been melted, a new layer is provided, and this will continue until the desired object is been obtained.

In SLM, the energy source is one or more laser beams and in EBM the energy source is an electron beam. SLM is carried out in an inert atmosphere, such as argon or nitrogen atmosphere. Additionally, the process may use support when it is needed, for example to reinforce small angles and the support will be removed afterwards. Additionally, SLM printing is performed directly on the loose powder layer.

In EBM, each powder layer will be preheated before they are locally fused by the electron beam. The process is performed in vacuum, of 1*10-5 bar and at high temperatures. Additionally, in EBM, each new powder layer is first pre-sintered with the electron beam before the actual printing of the powder layer starts.

According to one embodiment, the powder layer thickness is between 10 to 250 μm. For example, in SLM, the layer thickness from 10 to 80 μm, such as 10 to 45 μm and in EBM the layer thickness is from 10 to 250 μm.

According to an embodiment, the additive manufacturing process is direct energy deposition (DED). In this type of process, an energy source is used to create a local melt pool. Metal powder is feed into this melt pool as filler material. The position of the melt pool is constantly shifting so that a three-dimensional body is created by the solidifying material. The energy source may either be laser beam or a plasma arc. The heat generated from the source should be sufficient to melt the surface of the substrate and thereby form the melt pool. The powder is added to the pool by using a focused powder stream which means that the powder is pro-pulsed in the focused energy source and thereby fused. The DED process is normally performed with an inert shielding gas atmosphere protecting the melt pool. The material feed angle may be altered depending on what is the predetermined shaped object.

Further, due to the additive manufacturing process and the Fe—Cr—Al powder composition as defined hereinabove or hereinafter, post-treatments such as heat treatment or shape processing may not be necessary. Also, reductions in deposition rate may be avoided and thereby increasing the deposition productivity.

The additive manufactured object obtained from the Fe—Cr—Al powder as defined hereinabove or hereinafter will operate well in temperatures up to 1350° C. Furthermore, the present object will have a significant high-temperature corrosion resistance and a high resistance against oxidation, sulphidation and carburization. Additionally, the additive manufactured object will have significant high-temperature creep strength, form stability and high electrical resistivity. The additive manufactured object is especially useful as an electrical heating element or as a component in high temperature applications (in applications operating between 400 to 1350 ° C.). The additive manufactured object is also especially useful as a component in electrical heating applications. The object may also be used for protecting another object against high temperature wear and corrosion. Hence, the present object may be used in both electrical heating and high temperature applications.

The invention is further described by the following non-limiting examples

### EXAMPLES

### Powder Compositions

Four Fe—Cr—Al powders (see Table 1 for their composition) were produced with varied titanium and nitrogen content. Powder 1 and 2 are comparative example and Powder 3* and 4* are inventive powders. The powders were produced by induction melting and subsequent gas atomization. A metallic melt with the specified composition is poured through a small melt nozzle into an atomizing chamber filled with inert atmosphere. With a system of high velocity gas nozzles, the melt stream was disintegrated into very fine droplets which were cooled down and then transferred to solidified particles in-flight a fraction of a second. The particles were collected and cooled to ambient temperature within the inert atmosphere. The powders were sieved to −45 μm.

TABLE 1
Composition of the Fe—Cr—Al powders in weight %

| Powder | 1 | 2 | 3* | 4* |
|---|---|---|---|---|
| Gas | Ar | Ar | N₂ | N₂ |
| Fe | Balance | Balance | Balance | Balance |
| Cr | 20.88 | 21.01 | 20.93 | 20.29 |
| Al | 5.20 | 5.18 | 5.24 | 5.19 |
| Si | 0.24 | 0.26 | 0.29 | 0.27 |
| Ni | 0.24 | 0.18 | 0.21 | 0.18 |
| Mn | 0.19 | 0.15 | 0.17 | 0.17 |
| Ti | 0.50 | 0.07 | 0.24 | 0.49 |
| Zr | 0.074 | 0.075 | 0.077 | 0.073 |
| N | 0.024 | 0.044 | 0.073 | 0.10 |
| Y | 0.06 | 0.06 | 0.07 | 0.06 |
| C | 0.024 | 0.022 | 0.024 | 0.024 |
| P | 0.008 | 0.008 | 0.008 | 0.007 |
| S | 0.0002 | 0.0004 | 0.0002 | 0.0002 |
| O | 0.0073 | 0.01425 | 0.0060 | 0.0063 |

The grain refining effect through the introduction of TiN inoculants can be obtained and visually perceived already in the solidification microstructure of the as-atomized powders. Qualitatively, the degree of mono-crystallinity vis-á-vis polycrystallinity can be visually perceived through the “grain contrast imaging technique” or “electron channeling contrast imaging technique”, briefly described as follows. The Fe—Cr—Al powder is mixed with electrically conductive Bakelite powder and molded into a solid cylindrical puck. One of the flat surfaces of the puck is ground to sufficient depth and then polished to very high surface finish. Thereby, polished sections of a number of powder particles will be visible on this polished puck surface when analyzed by scanning electron microscope (SEM). The depth to which incoming SEM electrons penetrate the studied crystalline metal material and thereby also the number of back-scattered electrons that are reflected back depend on the crystal orientation of the studied crystals in the sample. Thus, grains of different crystal orientation vis-á-vis the direction of the incoming electrons will result in different amounts of reflected back-scatter electrons and thus ultimately to a difference in contrast between these studied grains. Consequently, this effect is best perceived with the back-scatter electron detector.

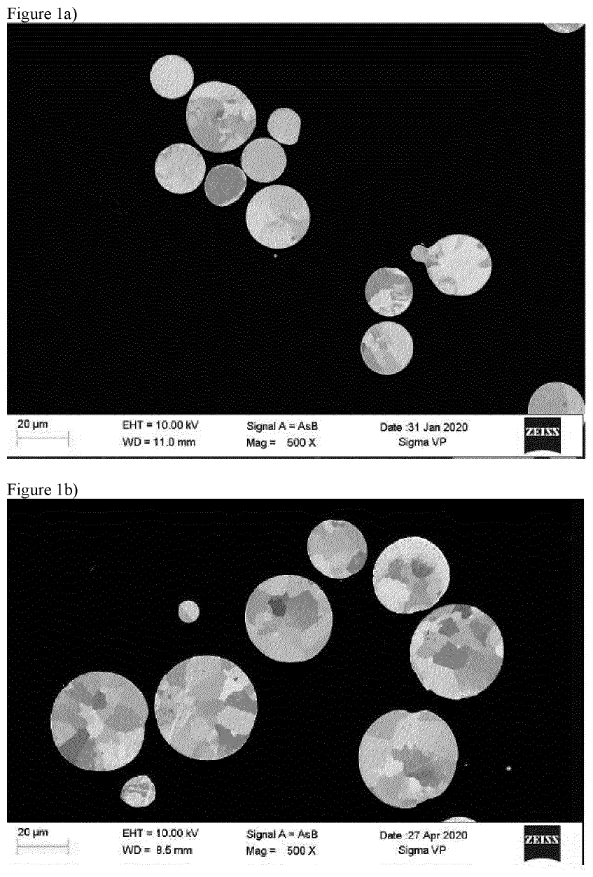

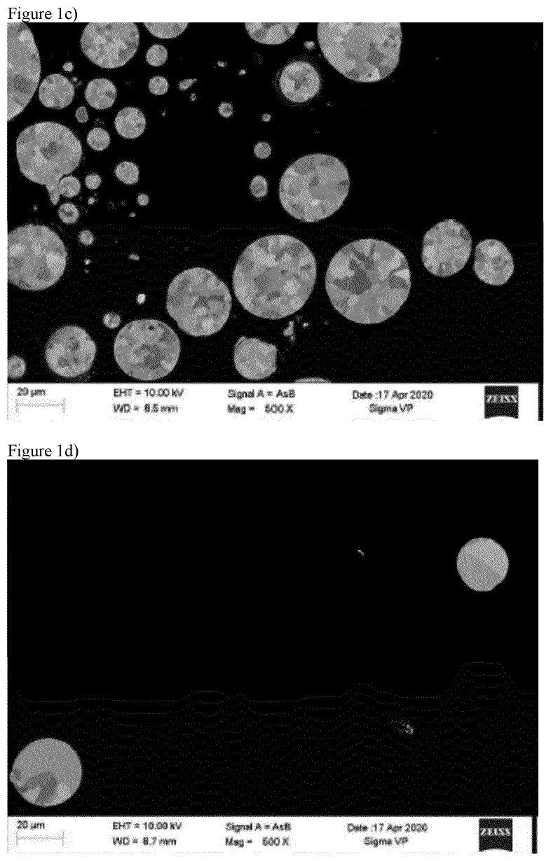

The results of this qualitative analysis performed on powder particles in the particle size range 1 to 45 μm from the four powders can be found in FIG. 1a-d). The results of this analysis are that the powder having a combination of a high titanium content and a high nitrogen content (Powder 4) had resulted in the highest degree of polycrystallinity and the smallest average grain size. The powder particles of Powder 4 also displayed the highest number of cubic TiN precipitates. The second highest degree of polycrystallinity was displayed by the powder having a medium level of titanium and nitrogen content (Powder 3). The powder with both low titanium content and low nitrogen content (Powder 2) is displaying the lowest degree of polycrystallinity. Powder 1 displayed none or only limited grain refinement. Thus, it is concluded that, in order to obtain the inoculant-imposed grain refinement, both the titanium level and the nitrogen level should be elevated simultaneously to obtain the TiN inoculants that promote the ferrite grain nucleation

Printing

A number of builds were printed from each of these powders, using the same printing parameter settings. The four different powders with compositions as described above were provided to a SLM machine by addition to the powder delivery system. During the printing process, the powder was provided from the powder delivery system in the machine and a scraper spread a layer of powder on the building plate. The laser then passed over the layer of powder according to a provided 3D drawing of cube of size 20×20×20 mm³, whereby the powder layer was exposed to the laser beam and therefore melted. After the layer of powder was melted, a new layer was provided until the desired sample(s) were formed according to the 3D drawing.

The thickness of the powder layers was 20 μm. The printing was performed in an inert atmosphere using argon. The scan speed was 500 mm/s. The power of the energy source was 95 W.

The sample was allowed to cool to room temperature in an inert atmosphere. Then, the as-built cube was cut from the building plate with no preceding heat treatment.

Evaluation

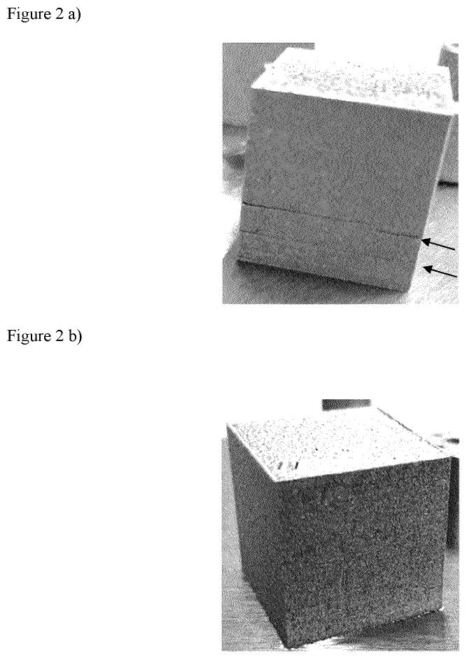

The four printed cubes were visually inspected. For the cubes comprising powder 3 or 4, no cracks could be observed to the contrary of the cubes comprising powder 1 or 2. FIG. 2a discloses the printed cube comprising Powder 2 (Object 2) where the cracks are visible (see arrows in FIG. 2a) and FIG. 2b discloses the printed cube comprising Powder 4 (Object 4).

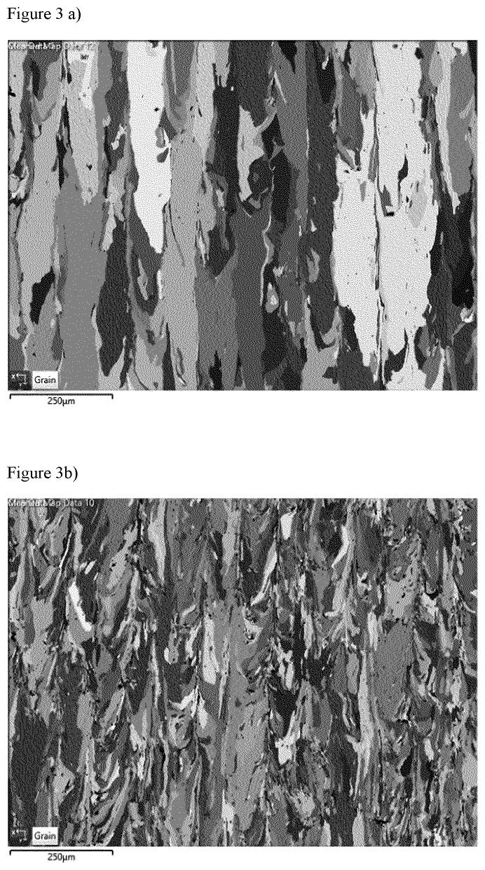

The microstructure was analyzed in the as-printed condition. The grain maps identified by electron backscatter diffraction (EBSD) analysis (acceleration voltage 20 kV, sampling size 1 μm, minimum 10 pixels per grain) of polished vertical sections parallel with the build direction of the cubes indicate that the cubes comprising Powder 4 (Object 4 in FIG. 3b) displays a clearly smaller grain size than the other cubes, as for the cubes comprising powder 2 (Object 2 in FIG. 3a). This difference is related to the increased levels of titanium and nitrogen. According to ECD; the 20 largest grains are 106±21 for Object 4 compared to 164±52 for object 2. Correspondingly, the grains/mm2>100 μm are 1428 for object 4 compared to 397 for Object 2.

The performed SEM+EBSD analysis on Object 4 shows that the solidification still occurs primarily epitaxially although with finer grains but that groups of grains are displaying a more equiaxed morphology are present. However, the SEM analysis has not been able to confirm by what mechanism the grain refinement has occurred for Powder 4 as compared to Powder 2. It may be a combination of grain boundary pinning and inoculation, both possibly correlated to the TiN inoculants in the melt pool.

The performed SEM+EBSD analysis on Object 2 shows columnar grains mostly aligned parallel to the build direction. The microstructure features coarse columnar grains up to mm in length. The epitaxial columnar growth of grains over multiple layers indicates the absence of active inoculants and inability to form fine grains within a melt pool by heterogeneous nucleation. The material is found highly crack susceptible wherein, majority of cracks are observed in transverse direction.

Tensile testing performed on the printed objects showed that object 4 has higher ductility than Object 2, probably due to the finer grains.

Oxidation testing showed similar results for the two objects; thus, the TiN inoculants have no negative impact on the oxidation resistance for Object 4.

Thus, a very positive influence of the TiN inoculants in the Fe—Cr—Al powder regarding grain refinement and crack tolerance in the as-built component is evident.

1. A Fe—Cr—Al powder having a composition (in weight %) comprising:
Cr 12.00 to 25.00;
Al 3.50 to 6.50;
Ti 0.20 to 1.10;
N 0.06 to 0.20;
Zr 0.05 to 0.20;
Y 0.02 to 0.15;
C≤0.050;
Si≤0.50;
Hf≤0.30;
Ta≤0.30;
Mn≤0.40;
Ni≤0.60;
O≤600 ppm;
balance Fe and unavoidable impurities;
wherein TiN is present as inoculant.

2. The Fe—Cr—Al powder according to claim 1, wherein the Cr content is from 18.0 to 24.0 wt.

3. The Fe—Cr—Al powder according to claim 1, wherein the Al content is from 4.0 to 6.0 wt %.

4. The Fe—Cr—Al powder according to claim 1, wherein the Ti content is from 0.30 to 1.00 wt %.

5. The Fe—Cr—Al powder according to claim 1, wherein the N content is from 0.09 to 0.20 wt %.

6. The Fe—Cr—Al powder according to claim 1, wherein the Zr content is from 0.07 to 0.10 wt %.

7. The Fe—Cr—Al powder according to claim 1, wherein Ti/N≥3.3.

8. The Fe—Cr—Al powder according to claim 1, wherein a powder size is less than 120 μm.

9. A process for manufacturing a three-dimensional object using an additive manufacturing process and the Fe—Cr—Al powder according to claim 1.

10. The process according to claim 9, wherein the additive manufacturing process is selected from a powder bed fusion or Direct Energy Deposition (DED) process.

11. The process according to claim 10, wherein the powder bed fusion process is SLM or EBM.

12. An additive manufactured object manufactured by the process according to claim 9.

13. The additive manufactured object according to claim 12, wherein the object is a high temperature resistant heating element or a high temperature resistant component.

14. An additive manufactured object comprising the powder according to claim 1.

15. The additive manufactured object according to claim 14, wherein the object is a high temperature resistant heating element or a high temperature resistant component.

16. The Fe—Cr—Al powder according to claim 1, wherein the Cr content is from 18.0 to 24.0 wt,
wherein the Al content is from 4.0 to 6.0 wt %,
wherein the Ti content is from 0.30 to 1.00 wt %.
wherein the N content is from 0.09 to 0.20 wt %,
wherein the Zr content is from 0.07 to 0.10 wt %,
wherein Ti/N≥3.3, and
wherein a powder size is less than 120 μm.
